(19) United States
(12) Patent Application Publication
(10) Pub. No.: US 2006/0000528 A1
(43) Pub. Date: Jan. 5, 2006

(54) METHOD FOR PRODUCING A GOLF CLUB WOOD

(75) Inventor: J. Andrew Galloway, Escondido, CA (US)

Correspondence Address: CALLAWAY GOLF C0MPANY, 2180 RUTHERFORD ROAD, CARLSBAD, CA, 92008-7328, US

(73) Assignee: CALLAWAY GOLF COMPANY, Carlsbad, CA (US)

(21) Appl. No.: 11/160,569

(22) Filed: Jun. 29, 2005

Related U.S. Application Data
(63) Continuation of application No. 60/521,761, filed on Jun. 30, 2004.

(51) Int. Cl. A63B 53/04; B32B 15/01; C21D 9/08; C22F 1/10

(52) U.S. Cl. 148/516; 473/324; 148/522

(57) ABSTRACT

A method for producing a golf club head (42) with a face component (60) and an aft-body (61) is disclosed herein. The face component (60), which includes a striking face (72) having a variable face thickness and a return portion is formed from a custom sheet or strip (50) of metal material that has been formed to have a desired thickness profile, with at least one portion of the sheet having a greater thickness than another section. A blank pattern of the face component (51) is cut from the sheet of metal material and formed into the face component (60). The face component (60) is then welded and attached to the aft-body (61).

### CROSS REFERENCES TO RELATED APPLICATIONS

The Present Application claims priority to U.S. Provisional Application No. 60/521,761, which was filed Jun. 30, 2005.

### BACKGROUND OF THE INVENTION

1. Field of the Invention

The present invention relates to a method for manufacturing a golf club head. More specifically, the present invention relates to a method for manufacturing a golf club head composed of a face component and an aft-body.

2. Description of the Related Art

When a golf club head strikes a golf ball, large impacts are produced that load the club head face and the golf ball. Most of the energy is transferred from the head to the golf ball, however, some energy is lost as a result of the collision. This energy transfer is measured using a coefficient of restitution, or “COR,” of the golf club head. Currently, the COR is restricted to 0.86 on a scale from 0.00 to 1.00 by Rule 4.1 of the Rules of Golf, as set forth by the United States Golf Association, “USGA,” and the Royals and Ancient Club of Saint Andrews. In the future, the USGA will likely further restrict the COR to 0.83.

The golf ball is typically composed of polymer cover materials (such as ionomers) surrounding a rubber-like core. These softer polymer materials having damping (loss) properties that are strain and strain rate dependent, which are on the order of 10-100 times larger than the damping properties of a metallic club face. Thus, during impact most of the energy is lost as a result of the high stresses and deformations of the golf ball (0.001 to 0.20 inches), as opposed to the small deformations of the metallic club face (0.025 to 0.050 inches). A more efficient energy transfer from the club head to the golf ball could lead to greater flight distances of the golf ball.

The generally accepted approach has been to increase the stiffness of the club head face to reduce metal or club head deformations. However, this leads to greater deformations in the golf ball, and thus increases in the energy transfer problem.

Some have recognized the problem and disclosed possible solutions. An example is Lu, U.S. Pat. No. 5,499,81 4, for a Hollow Club Head With Deflecting Insert Face Plate, discloses a reinforcing element composed of a plastic or aluminum alloy that allows for minor deflecting of the face plate which has a thickness ranging from 0.01 to 0.30 inches for a variety of materials including stainless steel, titanium, KEVLAR®, and the like. Yet another Campau invention, U.S. Pat. No. 3,989,248, for a Golf Club Having Insert Capable Of Elastic Flexing, discloses a wood club composed of wood with a metal insert.

Although not intended for flexing of the face plate, Viste, U.S. Pat. No. 5,282,624 discloses a golf club head having a face plate composed of a forged stainless steel material and having a thickness of 3 mm. Anderson, U.S. Pat. No. 5,344,140, for a Golf Club Head And Method Of Forming Same, also discloses use of a forged material for the face plate. The face plate of Anderson may be composed of several forged materials including steel, copper and titanium. The forged plate has a uniform thickness of between 0.090 and 0.130 inches.

Another invention directed toward forged materials in a club head is Su et al., U.S. Pat. No. 5,776,011 for a Golf Club Head. Su discloses a club head composed of three pieces with each piece composed of a forged material. The main objective of Su is to produce a club head with greater loft angle accuracy and reduce structural weaknesses.

Golf clubs can be manufactured in several ways. Generally, the clubs are assembled by welding compatible metal alloys into a closed volume. The hitting surface of the golf club head, called the striking face, is designed to provide the geometry and structure required to produce the desired trajectory and durability during ball impact.

Recently, through the use of stronger alloys, metals, and processing techniques, the striking face has been made more compliant. In addition, the construction of golf club heads has changed. Increasing the enclosed volume of the club head while keeping its overall mass constant optimizes the rotational inertia of the club head, providing greater forgiveness for off-center hits. To achieve this configuration, thinner materials or a combination of lighter (low density) materials and localized secondary mass materials is utilized. Despite these improvements, manufacturing a golf club with a high COR is still difficult using common manufacturing techniques known in the industry. In general, these design adjustments increase the cost of manufacturing a golf club and limit the vendor/supplier base.

Typically, the face component is made using materials consisting of wrought sheet or forged components of titanium or ultra high strength steel. The face component is then welded to a cast or fabricated metal body or is bonded to a non-metallic body. The shaping, heat treating and joining of these components increases both the raw material and manufacturing costs of the club heads.

Although the prior art has disclosed many variations of multiple material club heads, the prior art has failed to provide a multiple material club head with a high coefficient of restitution at a lower production cost. This invention overcomes the increased costs of the prior art by creating the face component of the golf club in a low cost, mass production process.

### BRIEF SUMMARY OF THE INVENTION

The present invention is a method for producing a face cup component that can be welded to a metallic aft-body, bonded to a non-metallic or metallic hybrid aft-body, or inserted into a molding for final contours and then bonded to additional body components to form a completed club head.

The manufacturing method allows a low cost implementation of a face component with variable face thickness that can increase striking face compliance and reduce face mass. The method involves custom rolling, extruding, machining or grinding a thickness profile in a sheet or strip of material before forming the material into the face component and cutting a blank pattern of the face component in the sheet of material. The face pattern blank is then formed into a completed face component that is joined to the aft-body.

In the preferred embodiment, the portion of the sheet or strip of material that will form the middle of the front face is thicker than the remaining areas of the sheet or strip. This minimizes the material utilized in the flanges and perimeter of the front face, while maintaining an increased thickness in the central region of the front face and in other areas where an increased thickness is preferred. This results in a more compliant striking face with lower energy loss and a higher coefficient of restitution. In addition, the reduced weight of the face component enables additional weight to be strategically distributed to other areas of the head to further enhance the playing characteristics of the golf club.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a front view of the golf club.

FIG. 1A is a front view of a golf club illustrating the measurement for the aspect ratio.

FIG. 2 is a rear view of a golf club head.

FIG. 3 is a toe side view of the golf club head of FIG. 2.

FIG. 4 is a heel side plan view of the golf club head of FIG. 2.

FIG. 5 is a top plan view of the golf club head of FIG. 2.

FIG. 6 is a bottom view of the golf club head of FIG. 2.

FIG. 7 is a cross-sectional view along line 7-7 of FIG. 5 showing one arrangement of a face component attached to an aft-body.

FIG. 7A is an isolated cross-sectional view of the face component overlapping the aft body according to the golf club of FIG. 7.

FIG. 8 is a cross-sectional view of another face component attached to an aft-body.

FIG. 8A is an isolated cross-sectional view of the face component welded flush to the aft body according to the golf club of FIG. 8

FIG. 9 is a cross-sectional view of a golf club head face component and aft-body according to a third embodiment of the present invention.

FIG. 9A is an isolated cross-sectional view of the aft-body overlapping the face component according to the golf club of FIG. 9.

FIG. 10 is a heel side plan view of a golf club of the present invention illustrating the Z axis and X axis.

FIG. 11 is a front plan view of a golf club of the present invention illustrating the Z axis and Y axis.

FIG. 12 is an isolated rear perspective view of a face component of a golf club head.

FIG. 13 is an isolated front view of a face component of the golf club head.

FIG. 14 is an isolated top plan view of an aft-body of the present invention.

FIG. 14A is an interior view of the aft-body of FIG. 14.

FIG. 14B is a heel side view of the aft-body of FIG. 14.

FIG. 14C is a toe side view of the aft-body of FIG. 14.

FIG. 15 is a top plan view of the layout of the custom material of the present invention.

FIG. 15A is a cross sectional view along line A-A of FIG. 15.

FIG. 16 is a flow chart of a method for producing the golf club head according to the present invention.

### DETAILED DESCRIPTION OF THE INVENTION

The present invention is directed at a method for producing a golf club head with an aft-body and a face component where the face component is formed from a customized sheet or strip of material. The face component has a front striking face and a return portion with a thin-walled flange and transition zone, which allow for greater compliance of the striking face during impact with a golf ball. The compliant striking face provides the golf club head with a high coefficient of restitution thereby enabling a golf ball hit with the golf club head of the present invention to travel a greater distance for a given club head speed. The coefficient of restitution is determined by the following equation:

$$e = \frac{{v}_{2} - {v}_{1}}{{U}_{1} - {U}_{2}}$$

wherein U₁ is the club head velocity prior to impact; U₂ is the golf ball velocity prior to impact which is zero; v₁ is the club head velocity just after separation of the golf ball from the face of the club head; v₂ is the golf ball velocity just after separation of the golf ball from the face of the club head; and e is the coefficient of restitution between the golf ball and the club face.

The values of e are limited between zero and 1.0 for systems with no energy addition. The coefficient of restitution, e, for a material such as a soft clay or putty would be near zero, while for a perfectly elastic material, where no energy is lost as a result of deformation, the value of e would be 1.0. The present invention provides a club head having a coefficient of restitution preferably ranging from 0.81 to 0.94, as measured under conventional test conditions.

The coefficient of restitution of the club head 42 of the present invention under standard USGA test conditions with a given ball preferably ranges from approximately 0.80 to 0.94, more preferably ranges from 0.82 to 0.883 and is most preferably 0.83.

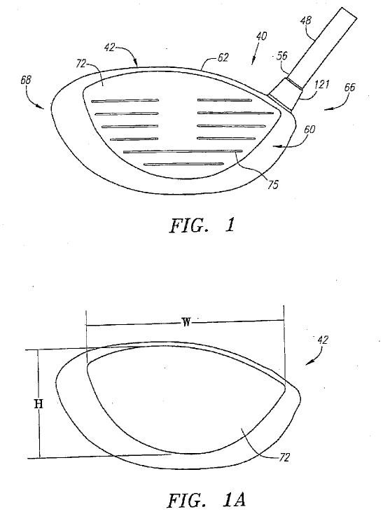

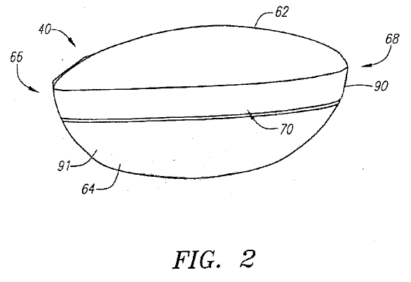

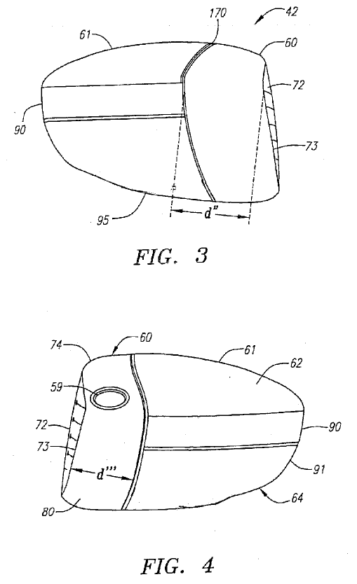

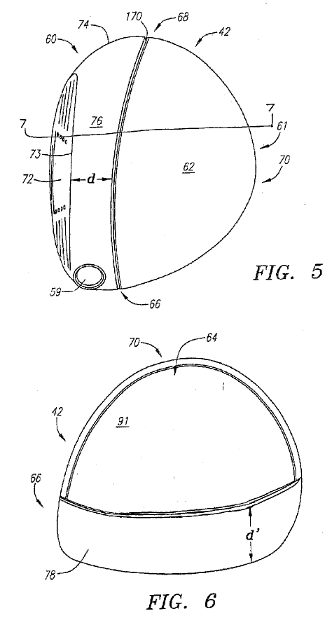

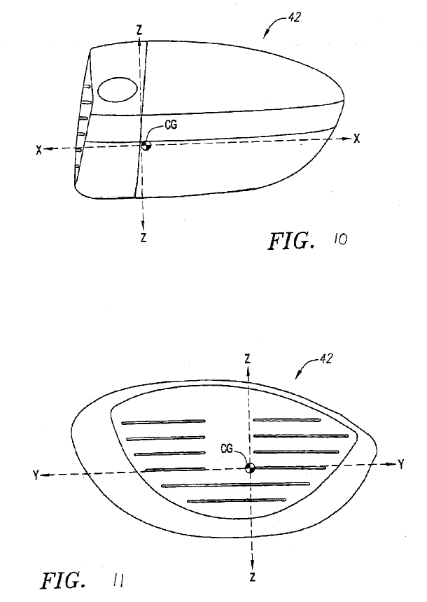

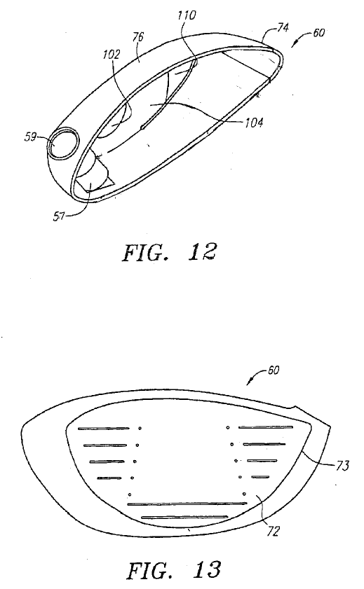

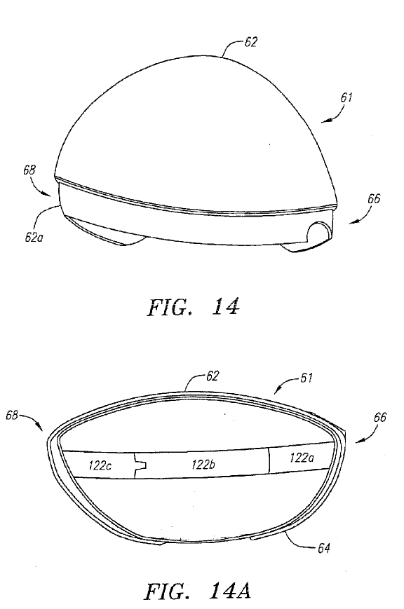

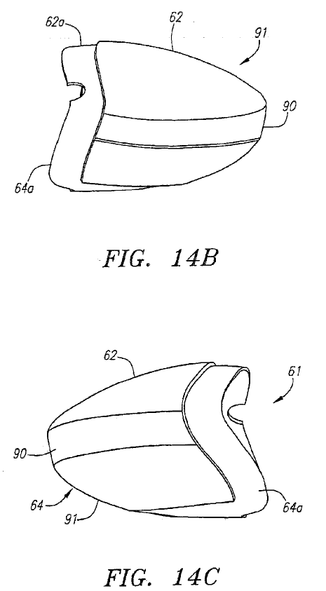

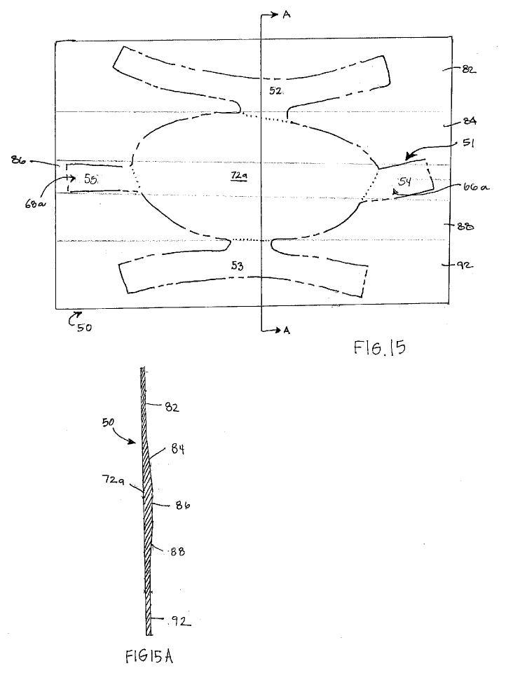

As shown in FIGS. 1-14A, a golf club is generally designated 40. The golf club 40 has a golf club head 42 with a hollow interior, not shown. Engaging the club head 42 is a shaft 48 that has a grip, not shown, at a butt end and is inserted into a hosel 57 at a tip end of the shaft 48.

The club head 42 is generally composed of two components, a face component 60, and an aft-body 61. The aft-body 61 has a crown portion 62 and a sole portion 64. The club head 42 may also be partitioned into a heel section 66 nearest the shaft 48, a toe section 68 opposite the heel section 66, and a rear section 70 opposite the face component 60.

The face component 60 has a front striking face 72 and return portion 77 that extends laterally rearward from the perimeter of the front face 60. The striking face 72 typically has a plurality of scorelines 75 thereon. The face component 60 engages the crown portion 62 of the aft-body 61.

In a preferred embodiment, the return portion 77 of the face component 60 generally includes an upper lateral section 76, a lower lateral section 78, a heel lateral section 80 and a toe lateral section 82. Thus, the return portion 77 preferably encircles the striking face 72 a full 360 degrees. However, those skilled in the pertinent art will recognize that the return portion 77 may only encompass a partial section of the striking face 72, such as 270 degrees or 180 degrees, and may also be discontinuous.

The upper lateral section 76 extends rearward, towards the aft-body 61, a predetermined distance, d, to engage the crown 62. In a preferred embodiment, the predetermined distance ranges from 0.2 inch to 1.0 inch, more preferably 0.40 inch to 0.75 inch, and most preferably 0.68 inch, as measured from the perimeter 73 of the striking face 72 to the rearward edge of the upper lateral section 76. In a preferred embodiment, the upper lateral section 76 has a general curvature from the heel section 66 to the toe section 68. The upper lateral section 76 has a length from the perimeter 73 of the striking face 72 that is preferably a minimal length near the center of the striking face 72, and increases toward the toe section 68 and the heel section 66. However, those skilled in the relevant art will recognize that the minimal length may be at the heel section 66 or the toe section 68.

The heel lateral section 80 is substantially perpendicular to the striking face 72, and the heel lateral section 80 covers the hosel 54 before engaging an optional ribbon section 90 and a bottom section 91 of the sole portion 64 of the aft-body 61. The heel lateral section 80 is attached to the sole portion 64, both the ribbon 90 and the bottom section 91, as explained in greater detail below. The heel lateral section 80 extends inward a distance, d′″, from the perimeter 73 a distance of 0.250 inch to 1.50 inches, more preferably 0.50 inch to 1.0 inch, and most preferably 0.950 inch. The heel lateral section 80 preferably has a general curvature at its edge.

At the other end of the face component 60 is the toe lateral section 82. The toe lateral section 82 is attached to the sole portion 64, both the ribbon 90 and the bottom section 91, as explained in greater detail below. The toe lateral section 82 extends inward a distance, d″, from the perimeter 73 a distance of 0.250 inch to 1.50 inches, more preferably 0.75 inch to 1.30 inch, and most preferably 1.20 inch. The toe lateral section 80 preferably has a general curvature at its edge.

The lower lateral section 78 extends inward, toward the aft-body 61, a predetermined distance, d′, to engage the sole 64. In a preferred embodiment, the predetermined distance ranges from 0.2 inch to 1.25 inches, more preferably 0.50 inch to 1.10 inch, and most preferably 0.9 inch, as measured from the perimeter 73 of the striking face 72 to the edge of the lower lateral section 78. In a preferred embodiment, the lower lateral section 78 has a general curvature from the heel section 66 to the toe section 68. The lower lateral section 78 has a length from the perimeter 73 of the striking plate 72 that is preferably a minimal length near the center of the striking plate 72, and increases toward the toe section 68 and the heel section 66.

The face component 60 is preferably composed of a metal material, such as titanium or steel. Alternatively, the face component 60 may be formed of a composite material, including a non-metal material that is molded over a metal piece. The metal portion of the face component 60 is preferably formed from a single sheet of metal material, as will be discussed in greater detail below.

The aft-body 61 may be composed of various materials including metals and composite materials. The metallic materials include magnesium, titanium, stainless steel, any other steel or titanium alloy, and others. Suitable composite materials include continuous fiber pre-preg material (including thermosetting materials or a thermoplastic materials for the resin), thermosetting materials or other thermoplastic materials such as injectable plastics. The aft-body 61 is preferably manufactured through bladder-molding, resin transfer molding, resin infusion, injection molding, compression molding, or a similar process.

The crown portion 62 of the aft-body 61 is generally convex toward the sole portion 64, and engages the ribbon section 90 of sole portion 64 outside of the engagement with the face component 60. Those skilled in the pertinent art will recognize that the sole portion 64 may not have a ribbon section 90. The crown portion 62 preferably has a thickness in the range of 0.010 to 0.100 inch, more preferably in the range of 0.025 inch to 0.070 inch, even more preferably in the range of 0.028 inch to 0.040 inch, and most preferably has a thickness of 0.033 inch. The sole portion 64, including the bottom section 91 and the optional ribbon section 90 which is substantially perpendicular to the bottom section 91, preferably has a thickness in the range of 0.010 to 0.100 inch, more preferably in the range of 0.025 inch to 0.070 inch, even more preferably in the range of 0.028 inch to 0.040 inch, and most preferably has a thickness of 0.033 inch.

FIG. 16 is a flow chart of a method, generally designated 200, of manufacturing the golf club head 40. The method 200 commences at block 202 with the forming of a custom strip or sheet 50 of a high strength metallic material such as titanium or steel. The strip of metallic material has a thickness profile that varies along different portions of the strip. A variation in the thickness of the custom strip or sheet is created by rolling portions of the strip or sheet of metallic material to reposition material, making certain sections of the strip thicker than others. Alternatively, the strip or sheet of metallic material may be machined, milled, or ground to remove material and decrease the thickness in certain sections. The custom sheet or strip may also be extruded with the desired thickness profile.

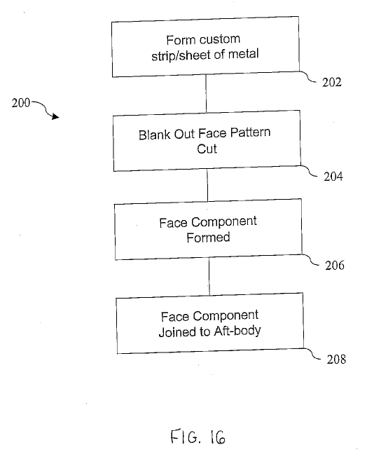

At step 204 a blank pattern of the face components to be formed is cut from the custom strip or sheet. FIGS. 15 and 15A illustrate a custom sheet or strip 50 that has a variation in thickness. The custom sheet 50 preferably has a central region 86 of increased thickness, outer regions 82 and 92 of reduced thickness, and transition regions 84 and 88. The thickness of the transition regions 84 and 88 gradually increases from the reduced thickness of the outer regions 82 and 92 to the increased thickness of the central region 86. A blank pattern 51 of the face component is shown in FIG. 15 positioned on the custom sheet 50. The blank pattern includes a face section 72a, a top flange 52, a bottom flange 53, and ribbon flanges 54 and 55. Flanges 52-55 extend from the face section 72a. The blank pattern 51 is preferably positioned on the custom sheet 50 such that the central region 86 of increased thickness is located at least along a central area of the face section 72a.

In a preferred embodiment, the central region 86 of increased thickness has a thickness that ranges from 0.110 inch to 0.076 inch, preferably from 0.100 inch to 0.081 inch, and is most preferably 0.050 inch. The transition regions 84 and 88 preferably have the next greatest thickness that ranges from the thickness of the central region 86 to the thickness of the flange sections 82 and 92. The outer regions 82 and 92 of the blank out face pattern 51 have the next greatest thickness that ranges from 0.040 inch 0.060 inch, and is most preferably 0.050 inch. The variation in the thickness of the custom sheet 50 allows for the greatest thickness to be localized in the center of the face section 72a, and therefore in the center of the front striking gace 72 of the face component 60. This central increased thickness maintains the flexibility of the front striking face 72 which corresponds to less energy loss to a golf ball and a greater coefficient of restitution without compromising the durability of the front face portion.

The blank pattern 51 of the face component may be cut from the custom sheet 50 of material using a laser cutting process or a water jet cutting process. Alternatively, the blank pattern 51 may be stamped from the custom sheet 50.

At step 206 the face component 60 is formed. The blank pattern 51 of the face component may be hot or cold formed to provide the front striking face 72 with the proper bulge and roll angles required by the given loft. Among the high strength materials that may be hot formed are pure titanium and titanium alloys such as 6-4 titanium alloy, SP-700 titanium alloy (available from Nippon Steel of Tokyo, Japan), DAT 55G titanium alloy available from Diado Steel of Tokyo, Japan, Ti 1 0-2-3 Beta-C titanium alloy available from RTI International Metals of Ohio, and the like. Other metals include high strength steel alloy metals such as AERMET 100 and AERMET 310 alloy steels, all available from Carpenter Specialty Alloys, of Pennsylvania. Among the material that may be cold worked during the forming process are maraging 300 and 250 steel, available from Alivac of North Carolina. Following the cold working process, the material is heat treated to obtain high strength properties.

The top flange 52, bottom flange 53, and ribbon flanges 55 and 54 are then folded to form the return portion 77 of the face component 60. Preferably, the top flange 52 and the bottom flange 53 are folded over the ribbon flanges 55 and 54. The incomplete face component 60 then undergoes a welding process where the face section 72a, top flange 82, bottom flange 53, and ribbon flanges 54 and 55 are welded to form a contiguously joined face component. The continuously joined face component may then be completed by a finishing operation, such as straightening, grinding, or polishing. Alternatively, the incomplete face component may be welded at certain locations to form a less than contiguous form and then over-molded with a non-metallic material to form a composite face component 60. Non-metallic materials that may be used to over-mold the metallic component include using a thermosetting materials, such as thermosetting polyurethane, or other thermoplastic materials such as polyamides, polyimides, polycarbonates, PBT (Polybutlene Terephthalate), blends of polycarbonate and polyurethane, and the like.

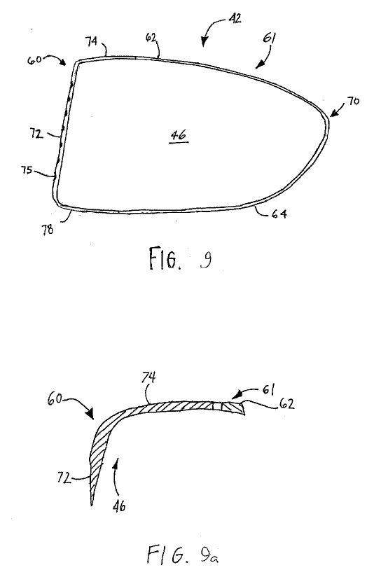

At step 208 the assembled face component 60 is attached to the aft body 61. In an attachment process shown in FIGS. 9 and 9A, the metallic face component 60 may be attached to a metallic aft-body 61 using a laser, e-beam, or other welding process known in the industry.

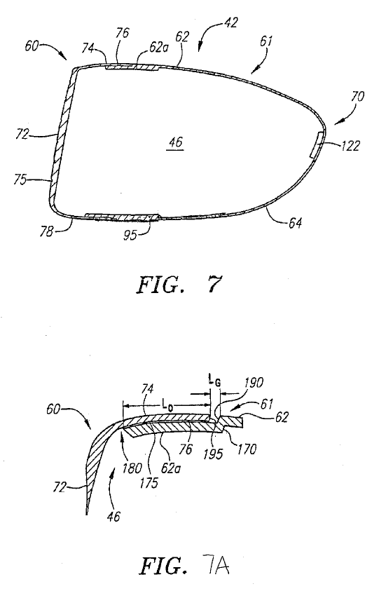

Alternatively, in a process shown in FIGS. 7 and 7A, the face component 60 may be placed within a mold with a preform of the aft-body 61 for bladder molding with an adhesive on the interior surface of the return portion 77. The sole portion 64 and crown portion 62 are each formed with undercut portions, sole undercut portion 64a and crown undercut portion 62a to be placed under the return portion 77. The return portion 77 is placed and fitted into the undercut portions 62a and 64a. Also, the adhesive may be placed on the undercut portions 62a and 64a. Such adhesives include thermosetting adhesives in a liquid or a film medium. During this attachment process, a bladder is placed within the hollow interior of the preform and face component 60, and is pressurized within the mold, which is also subject to heating. The co-molding process secures the aft-body 61 to the face component 60. In another attachment process, the aft-body 61 is first bladder molded and then is bonded to the face component 60 using an adhesive, or mechanically secured to the return portion 77.

As shown in FIG. 7A, the return portion 77 of the face component overlaps the undercut portions 62a and 64a a distance Lo, which preferably ranges from 0.25 inch to 1.00 inch, more preferably ranges from 0.40 inch to 0.70 inch, and is most preferably 0.40 inch.

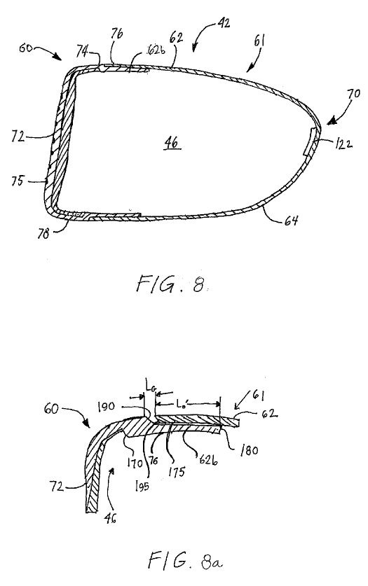

FIGS. 8 and 8A illustrate yet another method of attaching the face component 60 to the aft-body 61. The face component 60 includes composite overmolding with a sole undercut portion 64b and a crown undercut portion 62b to be placed under the aft-body 61. The aft-body 61 is fitted into the undercut portions 62b and 64b with the adhesive on the aft-body 61. Also, the adhesive may be placed on the undercut portions 62a and 64a.

As shown in FIG. 8A, the return portion 77 overlaps the undercut portions 62b and 64b a distance Lo′, which preferably ranges from 0.25 inch to 1.00 inch, more preferably ranges from 0.40 inch to 0.70 inch, and is most preferably 0.40 inch.

In FIGS. 7, 7A, 8, 8A, an annular gap 170 is created between an edge 190 of the crown portion 62 and the sole portion 64, and an edge 195 of the return portion 77. The annular gap 170 has a distance, Lg, which preferably ranges from 0.020 inch to 0.100 inch, more preferably from 0.050 inch to 0.070 inch, and is most preferably 0.060 inch. A projection 175 from an upper surface of the undercut portions 62a, 62b, 64a, and 64b establishes a minimum bond thickness between the interior surface of the return portion 77 and the aft-body 61. The bond thickness preferably ranges from 0.002 inch to 0.100 inch, more preferably ranges from 0.005 inch to 0.040 inch, and is most preferably 0.015 inch. A liquid adhesive preferably secures the aft body 61 to the face component 60. A leading edge 180 of the undercut portions 62a, 62b, 64a, and 64b may be sealed to prevent the liquid adhesive from entering the hollow interior 46.

The volume of the finished club head 42 produced in the present invention ranges from 250 cubic centimeters to 600 cubic centimeters, and more preferably ranges from 300 cubic centimeters to 510 cubic centimeters, even more preferably 345 cubic centimeters to 395 cubic centimeters, and most preferably 350 cubic centimeters. The volume of the golf club head 42 will also vary between fairway woods (preferably ranging from 3-woods to eleven woods) with smaller volumes and drivers, which will have larger volumes than the fairway woods.

The mass of the club head 42 produced in the present invention preferably ranges from 165 grams to 300 grams, more preferably ranges from 175 grams to 205 grams, and most preferably from 190 grams to 200 grams. Preferably, the face component 60 has a mass ranging from 50 grams to 110 grams, more preferably ranging from 65 grams to 95 grams, yet more preferably from 70 grams to 90 grams, and most preferably 78 grams. The aft-body 61 (without weighting) has a mass preferably ranging from 10 grams to 60 grams, more preferably from 15 grams to 50 grams, and most preferably 35 grams to 40 grams. The weighting member 122 (preferably composed of three separate weighting members 122a, 122b and 122c) has a mass preferably ranging from 30 grams to 120 grams, more preferably from 50 grams to 80 grams, and most preferably 60 grams. The interior hosel 54 preferably a mass preferably ranging from 3 grams to 20 grams, more preferably from 5 grams to 15 grams, and most preferably 12 grams. The sole plate 95 preferably a mass preferably ranging from 3 grams to 20 grams, more preferably from 5 grams to 15 grams, and most preferably 8 grams. Additionally, epoxy, or other like flowable materials, in an amount ranging from 0.5 grams to 5 grams, may be injected into the hollow interior 46 of the golf club head 42 for selective weighting thereof.

The depth of the club head 42 from the front striking face 72 to the rear section of the crown portion 62 preferably ranges from 3.0 inches to 4.5 inches, and is most preferably 3.75 inches. The height, H, of the club head 42, as measured while in address position, preferably ranges from 2.0 inches to 3.5 inches, and is most preferably 2.50 inches or 2.9 inches. The width, W, of the club head 42 from the toe section 68 to the heel section 66 preferably ranges from 4.0 inches to 5.0 inches, and more preferably 4.7 inches.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

What is claimed is:

1. A method for producing a golf club head including a face component and an aft-body, the method comprising:
forming a sheet of metal material, the sheet of metal material including at least a first region having a first thickness and a second region having a second thickness, the first thickness being greater that the second thickness;
cutting a blank pattern of the face component from the sheet6 of metal material, the blank pattern including a face section and a plurality of flanges extending from the face section, at least a portion of the face section having the first thickness;
forming a the blank pattern into completed face component, the face component including a front face and a return portion; and
securing the return portion of the face component to an aft-body to form an assembled golf club head.

2. The method according to claim 1 wherein forming the sheet of metal material includes milling the sheet to the desired thickness profile.

3. The method according to claim 1 wherein forming the sheet of metal material includes rolling the sheet to the desired thickness profile.

4. The method according to claim 1 wherein forming the sheet of metal material includes extruding the sheet to the desired thickness profile.

5. The method according to claim 1 wherein forming the sheet of metal material includes grinding the sheet to the desired thickness profile.

6. The method according to claim 1 wherein the blank pattern is cut using a laser cutting process.

7. The method according to claim 1 wherein the blank pattern is cut using a water jet cutting process.

8. The method according to claim 1 wherein the blank pattern is cut by stamping the sheet of metal material.

9. The method according to claim 1 wherein forming the blank pattern into the completed face component comprises: hot forming the blank pattern to provide the front face with a bulge angle and a roll angle; and bending the plurality of flanges with respect to the face section to form the return portion.

10. The method according to claim 9 wherein the sheet of metal material is selected from the group consisting of titanium alloys and certain steels.

11. The method according to claim 9 wherein forming the blank pattern into the completed face component further comprises over-molding the face section and the plurality of flanges with a non-metallic material.

12. The method according to claim 1 wherein forming the blank pattern into the completed face component comprises: cold forming the blank pattern to provide the front face with a bulge angle and a roll angle; and bending the plurality of flanges with respect to the face section to form the return portion.

13. The method according to claim 11 further comprising head treating the face component.

14. The method according to claim 1 wherein the completed face component is formed using a progressive die stamping process.

15. The method according to claim 1 wherein securing the face component to the aft-body includes welding the face component to the aft-body, the welding occurring on the interior surface of the face component.

16. A method for producing a golf club head including a face component and aft-body, the method comprising:
forming a sheet of metal material to a desired thickness profile, the sheet of metal material including at least a first region having a first thickness and a second region having a second thickness, the first thickness being greater than the second thickness;
cutting a blank pattern of the face component from the sheet of metal material, the blank pattern including a face section and a plurality of flanges extending from the face section, at least a portion of the face section having the first thickness;
progressive die stamping the blank pattern into the face component, the face component including a front face and a return portion, the return portion being formed by the plurality of flanges;
welding the face into a contiguous body, the welding occurring on an interior surface of the face component; and
securing the face component to the aft-body to form an assembled golf club head.

17. The method according claim 16 wherein securing the face component to the aft-body includes welding the return portion to the aft-body.

18. The method according to claim 16 wherein the welding includes any one of laser welding, plasma welding, and e-beam welding.

19. A method for producing a golf club head including a face component and aft-body, the method comprising:
forming a sheet metal material to a desired thickness profile, the sheet of metal material including at least a first region having a first thickness and a second region having a second thickness, the first thickness being greater than the second thickness;
cutting a blank pattern of the face component from the sheet of metal material, the blank pattern including a face section and a plurality of flanges extending from the face section, at least a portion of the face section having the first thickness;
progressive die stamping the blank pattern into the face component, the face component including a front face and a return portion, the return portion being formed by the plurality of flanges;
welding the face component, the welding occurring on the interior surface of the face component;
over-molding the face component with a non-metallic material to form a completed face component; and
securing the completed face component to the aft-body to form an assembled golf club head.
